(19) United States
(12) Patent Application Publication
(10) Pub. No.: US 2022/0025524 A1
(43) Pub. Date: Jan. 27, 2022

(54) SYSTEM AND METHOD FOR SERVICE LIFE MANAGEMENT USING CORROSION MANAGED CONNECTORS

(71) Applicant: Dell Products L.P., Hopkinton, MA (US)

(72) Inventors: Steven Embleton, Austin, TX (US); Jon Taylor Fitch, Austin, TX (US)

(21) Appl. No.: 16/938,405

(22) Filed: Jul. 24, 2020

(51) Int. Cl. C23F 13/00; H01R 13/03; H01R 13/533; G06F 1/20

(52) U.S. Cl. CPC C23F 13/005; G06F 1/206; H01R 13/533; H01R 13/03

(57) ABSTRACT

A computing device of an information handling system includes a connector that receives a component, the connector including a contact that forms a physical connection, with the component, that supports an electrical connection between the connector and the component, the contact includes an interface surface, disposed in a high corrosion risk area of the connector, that forms the physical connection with the component while the component is disposed in the connector. The computing device also includes a corrosion management component that: reduces a rate of corrosion of the contact in the high corrosion risk area of the connector, and increases a second rate of corrosion in a low corrosion risk area of the connector.

### BACKGROUND

As the value and use of information continues to increase, individuals and businesses seek additional ways to process and store information. One option available to users is information handling systems. An information handling system (IHS) generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Use cases for information handling systems are causing progressively larger number of information handling systems to be disposed near each other. For example, rack mount systems utilize a rack structure to stack many information handling systems in a vertical arrangement. Due to the changing uses of information handling systems, chassis of information handling systems may modular. That is, a chassis may be composed of multiple enclosures that may be attached to each other to form the chassis of the information handling systems. When the multiple enclosures are attached, components of the information handling system disposed in each of the enclosures may become operably connected to each other.

### SUMMARY

In one aspect, a computing device of an information handling system in accordance with one or more embodiments of the invention includes a connector that receives a component, the connector including a contact that forms a physical connection, with the component, that supports an electrical connection between the connector and the component, the contact includes an interface surface, disposed in a high corrosion risk area of the connector, that forms the physical connection with the component while the component is disposed in the connector; and a corrosion management component that: reduces a rate of corrosion of the contact in the high corrosion risk area of the connector, and increases a second rate of corrosion in a low corrosion risk area of the connector.

In one aspect, a method for environmentally managing a computing device of an information handling system in accordance with one or more embodiments of the invention includes monitoring an environmental corrosion risk associated with a connector of the computing device, the connector is physically connected to a corrosion management component that: reduces a rate of corrosion of the connector in a high corrosion risk area of the connector, and increases a second rate of corrosion in a low corrosion risk area of the connector; making a determination that the connector is associated with the corrosion management component; in response to the determination: estimating a corrosion risk of the connector based on: the environmental corrosion risk, and a risk reduction factor associated with the corrosion management component; making a second determination that the corrosion risk of the connector indicates a premature failure of the connector; and remediating the corrosion risk of the connector based on the second determination.

In one aspect, non-transitory computer readable medium includes computer readable program code, which when executed by a computer processor enables the computer processor to perform a method for environmentally managing a computing device of an information handling system, the method in accordance with one or more embodiments of the invention includes monitoring an environmental corrosion risk associated with a connector of the computing device, the connector is physically connected to a corrosion management component that: reduces a rate of corrosion of the connector in a high corrosion risk area of the connector, and increases a second rate of corrosion in a low corrosion risk area of the connector; making a determination that the connector is associated with the corrosion management component; in response to the determination: estimating a corrosion risk of the connector based on: the environmental corrosion risk, and a risk reduction factor associated with the corrosion management component; making a second determination that the corrosion risk of the connector indicates a premature failure of the connector; and remediating the corrosion risk of the connector based on the second determination.

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1.1 shows a diagram of an information handling system in accordance with one or more embodiments of the invention.

FIG. 1.2 shows a diagram of a building that includes information handling systems in accordance with one or more embodiments of the invention.

FIG. 1.3 shows a diagram of a chassis of an information handling systems in accordance with one or more embodiments of the invention.

FIG. 1.4 shows a diagram of computing components in accordance with one or more embodiments of the invention.

FIG. 1.5 shows a side diagram of a connector of computing components integrated with corrosion management components in accordance with one or more embodiments of the invention.

FIGS. 1.6-1.9 show side view diagrams of a contact of a connector lacking an integrated corrosion management component in accordance with one or more embodiments of the invention.

FIGS. 1.10-1.12 show side view diagrams of a contact of a connector having an integrated corrosion management component in accordance with one or more embodiments of the invention.

FIG. 1.13 shows a side diagram of the connector of FIG. 1.5 after it has corroded and received a device connector in accordance with one or more embodiments of the invention.

FIG. 2 shows a diagram of an environmental manager of an information handling system in accordance with one or more embodiments of the invention.

FIG. 3 shows a flowchart of a method of managing corrosion of a connector of an information handling system in accordance with one or more embodiments of the invention.

FIG. 4 shows a diagram of a computing device in accordance with one or more embodiments of the invention.

### DETAILED DESCRIPTION

Specific embodiments will now be described with reference to the accompanying figures. In the following description, numerous details are set forth as examples of the invention. It will be understood by those skilled in the art that one or more embodiments of the present invention may be practiced without these specific details and that numerous variations or modifications may be possible without departing from the scope of the invention. Certain details known to those of ordinary skill in the art are omitted to avoid obscuring the description.

In the following description of the figures, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

In general, embodiments of the invention relate to systems, devices, and methods for managing components of an information handling system. An information handling system may be a system that provides computer implemented services. These services may include, for example, database services, electronic communication services, data storage services, etc.

To provide these services, the information handling system may include one or more computing devices. The computing devices may include any number of computing components that facilitate providing of the services of the information handling system. The computing components may include, for example, processors, memory modules, circuit cards that interconnect these components, etc. The computing component may be connector to one another using connectors.

During operation, these connectors may be exposed to gases that may cause the connectors to corrode. Corrosion may cause the connectors to fail to properly connect the computing components with one another.

For example, the corrosion on a connector may prevent the connector with mating to a connector of another device. The corrosion may prevent surfaces of the connector from physically contacting surfaces of the connector of the other device. Consequently, electrical connections through these surfaces may not be formed or may be of low quality due to the electrical resistance imparted by the corrosion. Thus, an IHS may enter a failure state (e.g., suffer a premature failure) or be impaired if the mating surfaces of the connectors become corroded.

Embodiments of the invention may provide methods and systems that reduce the risk of connector corrosion related failures in information handling systems. To reduce the risk of connection corrosion related failures, the system may include corrosion management components. A corrosion management component may reduce the rate of corrosion of one or more connectors even when the connectors are exposed to environmental conditions that would cause corrosion.

To reduce the rate of corrosion, the corrosion management components change the reactivity of the mating surfaces (and/or other portions) of the connectors. For example, the corrosion management components may create an electrical potential that reduces the chemical reactivity of a managed connector.

In one or more embodiments of the invention, the corrosion management component includes chemically reactive metals that, when placed in contact with a connector, form a potential cell with all, or a portion, of the connector. The potential cell may generate the electrical potential between the connector and the corrosion management component. For example, if a component is formed from copper, a corrosion management component may include zinc metal which, when place in contact with the copper, creates a potential cell.

Corrosion management components may be strategically disposed on different connectors to reduce their susceptibility to corrosion related failure. For example, corrosion management components may be integrated with corrosion management components that are disposed in cooler portions of a chassis. The cooler temperatures may increase the likelihood of corrosion occurring at faster rates. In contrast, corrosion management components may not be integrated with connectors that are likely to be kept at warmer temperatures.

The corrosion management components may be disposed away from interface surfaces of the connectors. When connectors interconnect with one another, the connectors may make physical contact with one another to form electrical connections. To reduce the corrosion of these surfaces, corrosion management components may be disposed near, but away from the interface surfaces. Consequently, the corrosion management components may still provide corrosion management services for these interface services without introducing corrosion into these (or other) contact surfaces by virtue of their placements.

By doing so, a system in accordance with embodiments of the invention may be less likely to prematurely fail due to corrosion of its connectors, be more likely to meet its service life goal, be able to accept a wider range of intake gas conditions that may be more likely to cause corrosion without negatively impacting the system, and/or may be less costly to operate by reducing the necessary level of conditioning of gases taken into the chassis of the information handling systems for cooling purposes.

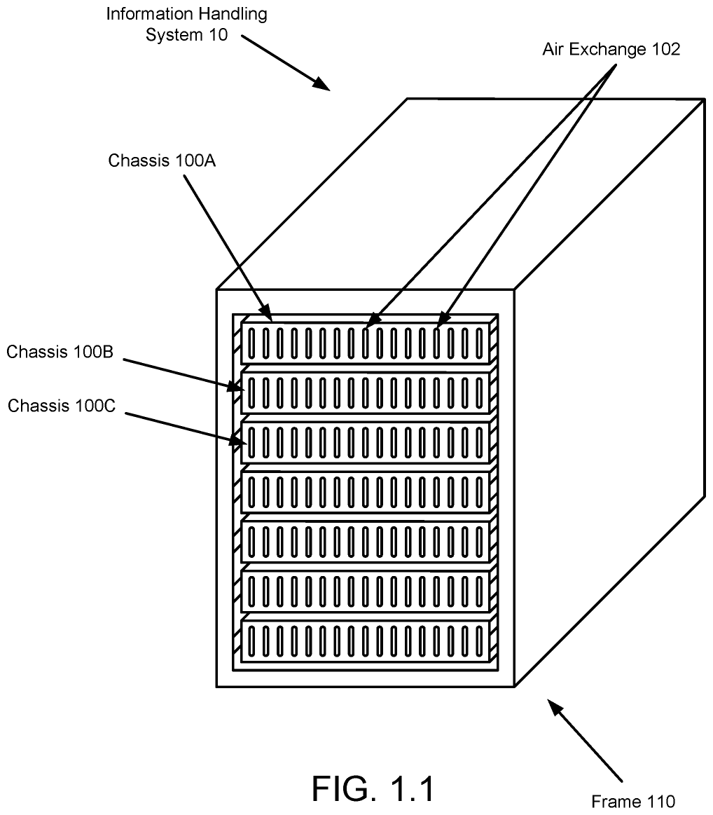

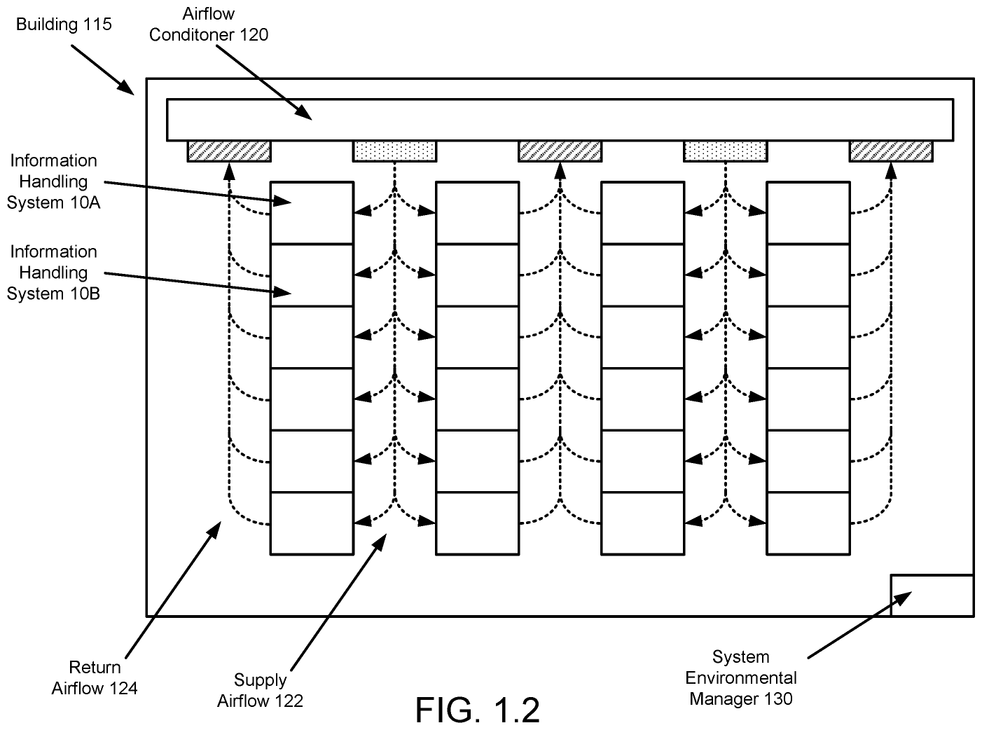

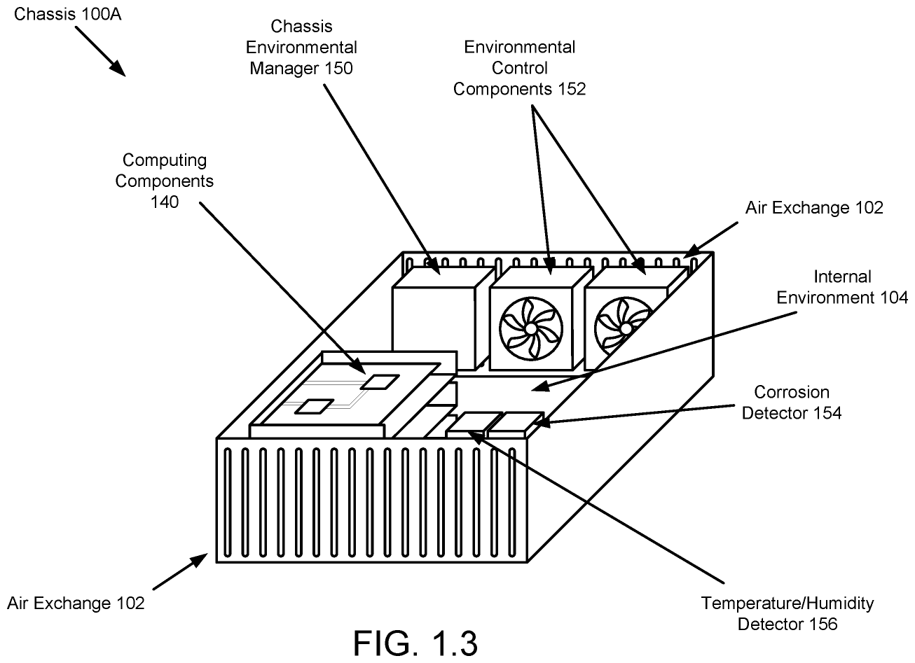

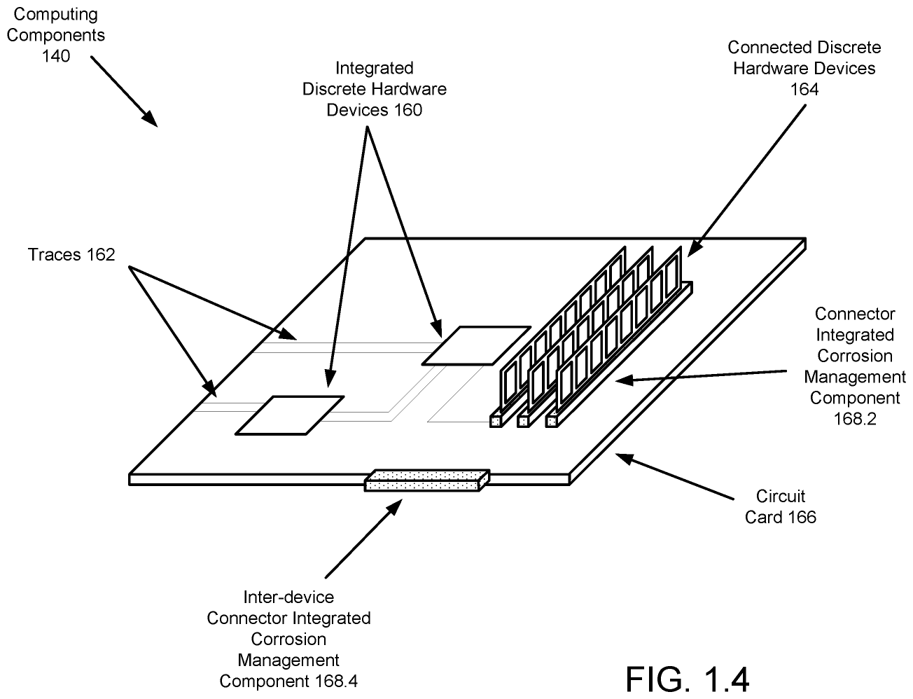

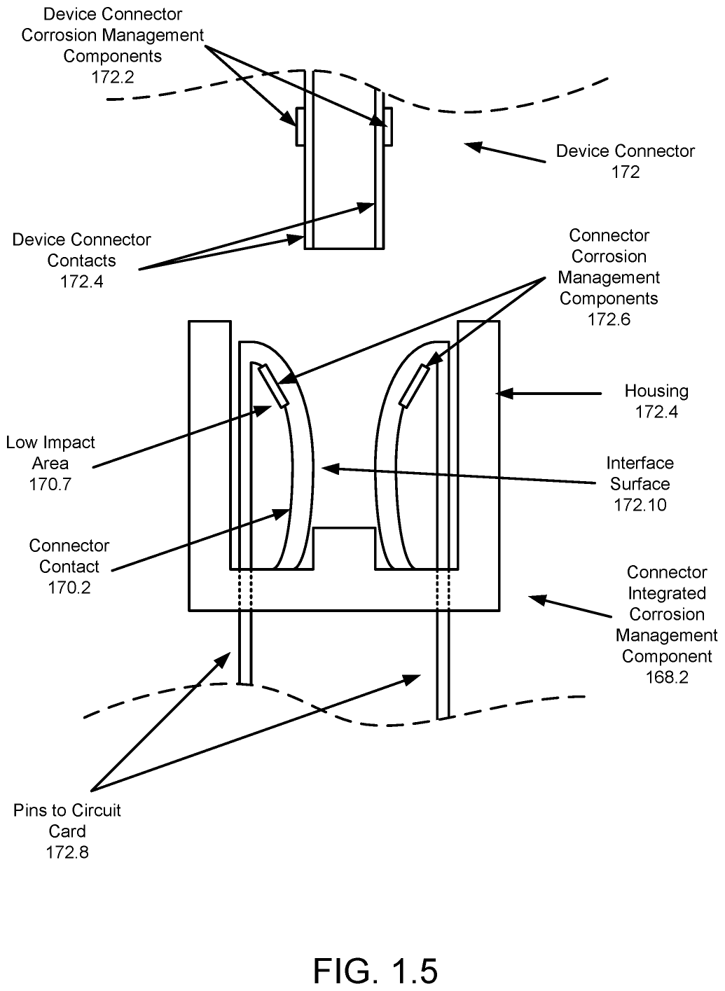

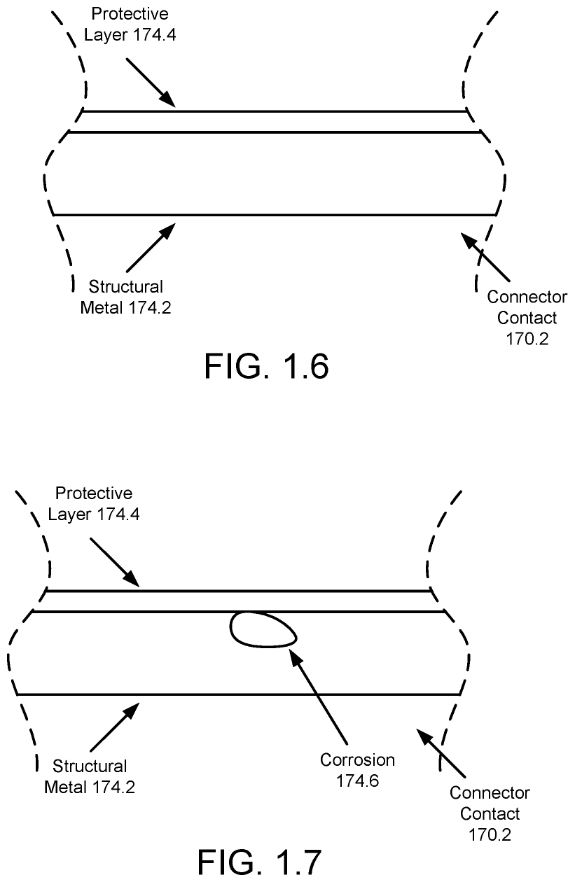

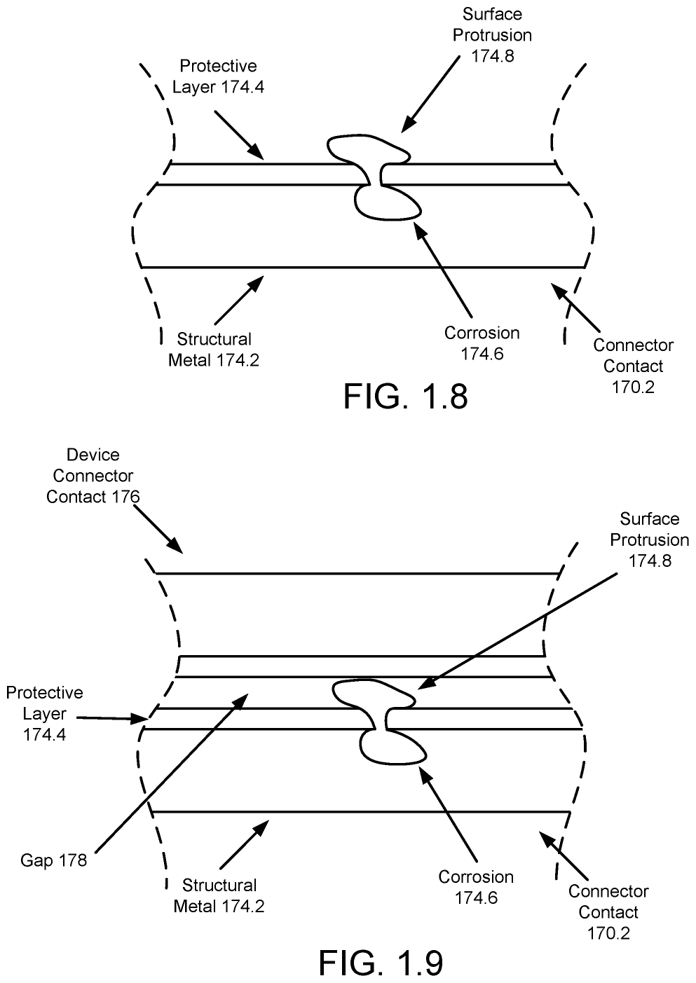

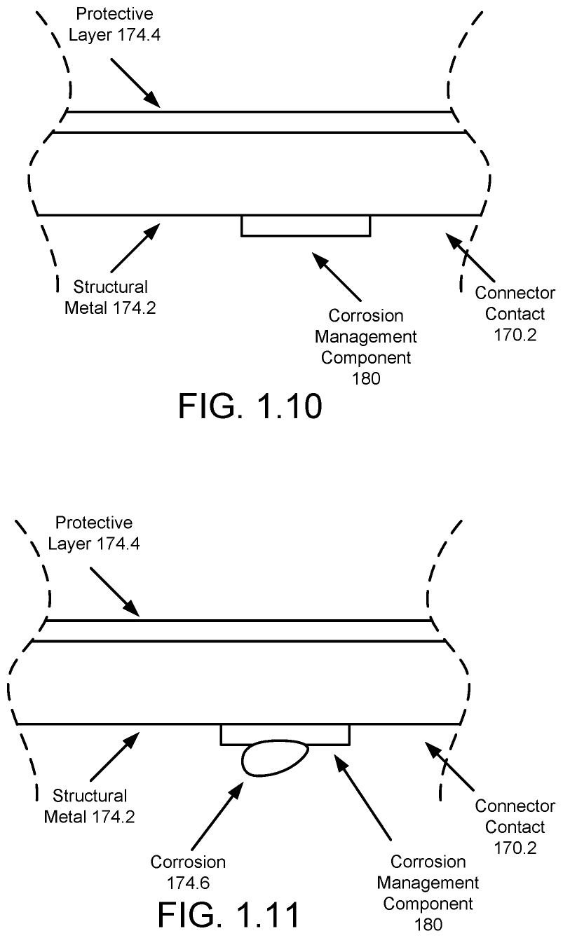

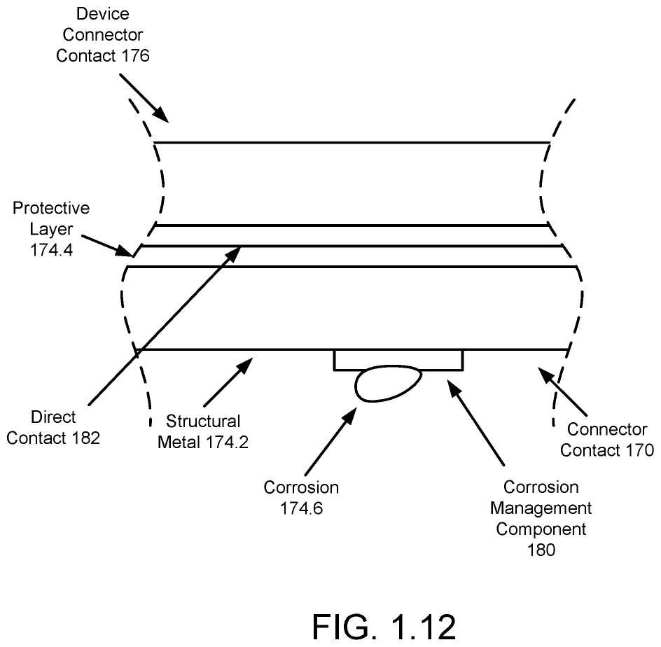

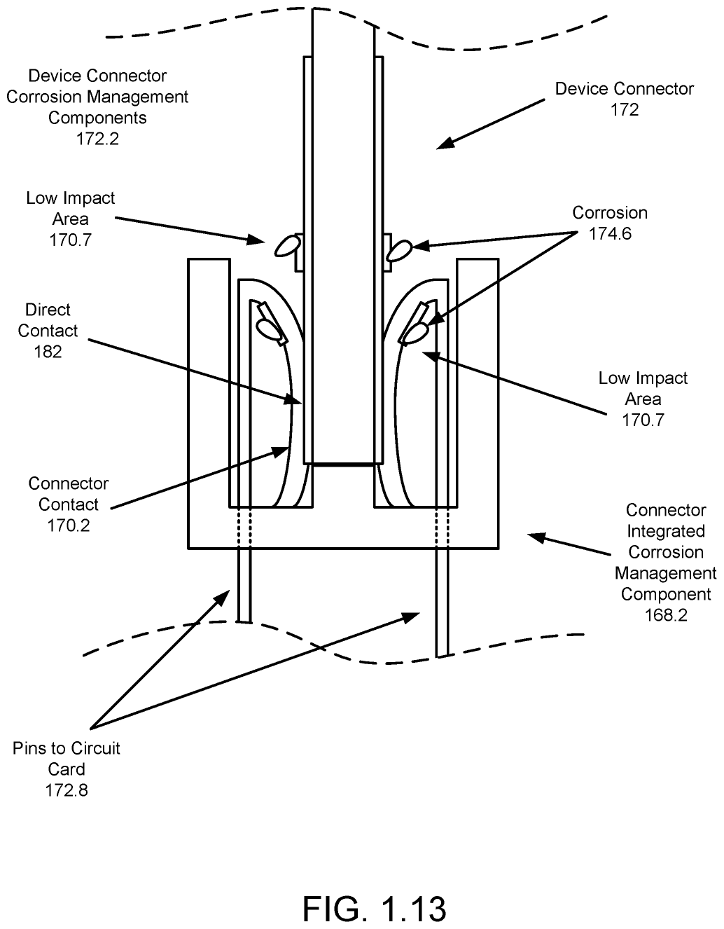

FIG. 1.1 shows an information handling system (10) in accordance with one or more embodiments of the invention. The system may include a frame (110) and any number of chassis (e.g., 110A, 100B, 100C).

The frame (110) may be a mechanical structure that enables chassis to be positioned with respect to one another. For example, the frame (110) may be a rack mount enclosure that enables chassis to be disposed within it. The frame (110) may be implemented as other types of structures adapted to house, position, orient, and/or otherwise physically, mechanically, electrically, and/or thermally manage chassis. By managing the chassis, the frame (110) may enable multiple chassis to be densely packed in space without negatively impacting the operation of the information handling system (10).

A chassis (e.g., 100A) may be a mechanical structure for housing components of an information handling system. For example, a chassis may be implemented as a rack mountable enclosure for housing components of an information handling system. The chassis may be adapted to be disposed within the frame (110) and/or utilize services provided by the frame (110) and/or other devices.

Any number of components may be disposed in each of the respective chassis (e.g., 100A, 100B, 100C). These components may be portions of computing devices that provide computer implemented services, discussed in greater detail below.

When the components provide computer implemented services, the components may generate heat. For example, the components may utilize electrical energy to perform computations and generate heat as a byproduct of performing the computations. If left unchecked, buildup of heat within a chassis may cause temperatures of the components disposed within the chassis to exceed preferred ranges.

The preferred ranges may include a nominal range in which the components respectively operate (i) without detriment and/or (ii) are likely to be able to continue to operate through a predetermined service life of a component. Consequently, it may be desirable to maintain the temperatures of the respective components within the preferred range (e.g., a nominal range).

When a component operates outside of the preferred range, the service life of the component may be reduced, the component may not be able to perform optimally (e.g., reduced ability to provide computations, higher likelihood of error introduced into computations, etc.), and/or the component may be more likely to unexpectedly fail. The component may be subject to other undesirable behavior when operating outside of the preferred range without departing from the invention.

To operate components within the preferred range of temperature, the chassis may include air exchanges (e.g., 102). An air exchange (102) may be one or more openings in an exterior of a chassis that enables the chassis to exchange gases with an ambient environment. For example, a chassis may utilize air exchanges to (i) vent hot gases and (ii) intake cool gases. By doing so, the temperature of the gases within the chassis may be reduced. Consequently, the temperatures of components within the chassis may be reduced by utilizing the cooler gases taken into the chassis via an air exchange.

However, utilizing gases to cool components within a chassis may be problematic. The gases may not be benign. For example, the gases may be (i) chemically reactive, (ii) include humidity, and/or (iii) otherwise interact with components disposed within the chassis in an undesirable manner. The reaction between the gases used to cool the components and the components themselves (or other components proximate to the to-be-cooled components) may negatively impact the components disposed within the chassis.

For example, if the gases include a chemically reactive component (e.g., chlorine species), the gases may react (i.e., chemically react) with portions of the components disposed within the chassis. These reactions may damage portions of the components resulting in a decreased service life of the components.

In another example, if the gases include humidity, the humidity may (under certain conditions) condense resulting in water being disposed on the surfaces of the components. When water is disposed on the surfaces of components (even at very small levels), the water may chemically react with the components forming corrosion. The aforementioned reactions with the condensed water may damage the components or otherwise cause them to operate in an undesirable manner.

The reactions, discussed above, may cause numerous negative impacts. First, the reactions may impact the electrical conductivity of various components. For example, when metals react with chemically reactive species, condensed water vapor, etc., the metals may form chemical compounds that are substantially less conductive than the pure metals. The reduced conductivities of the components may negatively impact the electrical functionality of the components (e.g., circuits) disposed within the chassis.

Second, the reactions may impact the physical size of various components. For example, when metals chemically react, the products formed by the reactions may occupy significantly larger volumes than the unreacted metals (e.g., metal oxides vs elemental metals). The change in volumes of the reacted metals may negatively impact the electrical functionality of the components by, for example, forming open circuits by physically disconnecting various portions of the components from each other and/or other devices.

The potential reactions may cause other negative impacts beyond those discussed herein. The negative impacts may cause a device to fail prior to it meeting its service life. A service life may be a desired duration of operation of a component, device, or system.

To address the above and/or other potential issues, embodiments of the invention may provide methods, devices, and systems that mitigate corrosion. To mitigate corrosion, corrosion management components may be utilized. A corrosion management component may be a component that limits the occurrence of corrosion of one or more components for which the corrosion management component provides corrosion management services. In one or more embodiments of the invention, corrosion management components are integrated with other components (e.g., integrated corrosion management components) as opposed to being standalone/physically distinct components.

To provide corrosion management services, the corrosion management components may modify the reactivity of components for which they provide corrosion management services. For example, the corrosion management components may modify the corrosion susceptibility of other components.

To modify the corrosion susceptibility of other components, the corrosion management components may generate a voltage potential between the managed component and the corrosion management component (e.g., by forming a potential cell). The voltage potential may reduce the likelihood that the managed component will react with gases or condensed liquids at the cost of the corrosion management components itself reacting. For example, the voltage potential may create free charge in the managed component that reduces the likelihood of chemical reactions from occurring. Consequently, corrosion that may typically occur at one location may be reduced while increasing the occurrence of corrosion at another location. By strategically placing the locations at which corrosion is enhanced, the impact (e.g., corrosion induced damage/failure) of corrosion on components may be reduced.

In one or more embodiments of the invention, the corrosion management components are implemented as sacrificial anodes. A sacrificial anode may be a portion of material that, when placed in contact with another material, forms a potential cell with between the two components. The potential cell may preferentially charge a managed component in a manner that makes it less chemically reactive and may preferentially charge the corrosion management component in a manner that makes it more chemically reactive.

For example, if a to-be-managed component is formed of copper metal, a corrosion management component may be a portion of zinc, aluminum, magnesium, or another material which is more chemically active than the copper metal and forms a potential cell with it. When placed in direct contact with the copper metal, a potential cell may be formed thereby causing the copper metal to be less susceptible to corrosion while the zinc material becomes more likely to corrode (e.g., at rates higher than would occur without the formation of the potential cell). Consequently, when the corrosion management component is placed in contact with the managed component, the corrosion susceptibility of the managed component may be greatly reduced at the cost of the zinc material corroding at an accelerated rate (when compared to the rate of corrosion when the zinc material is not in contact with the copper material).

In one or more embodiments of the invention, a managed component is a connector. As will be discussed in greater detail below, connectors may be particularly sensitive to corrosion. This susceptibility to corrosion may be due to particular features (e.g., surfaces that must contact other surfaces for the connector to perform its functionality) of the connector. To address the connector's corrosion's susceptibility to corrosion, corrosion management components may be integrated with the connectors. The corrosion management components may be integrated (e.g., strategically placed) in a manner that reduces corrosion of the connectors in regions of the connector that are particularly susceptible to corrosion related issues while increasing corrosion in other areas of the connector that are less sensitive (e.g., insensitive such that the presence of corrosion does not prevent the connector from providing its functionality when the corrosion is present in the other areas) to corrosion. By doing so, a connector in accordance with embodiments of the invention may: (i) be more likely to meet its service life goals, (ii) be able to operate for its service life in harsher environment that are more likely to cause high rates of corrosion, (iii) enable less energy to be used for environment conditioning purposes (e.g., to reduce corrosion), and/or (iv) may reduce the cost of servicing a device (e.g., a computing device, IHS, etc.) in which the connector is integrated by reducing the number of service calls for managing the device during its service life.

For additional details regarding corrosion management components, refer to FIGS. 1.4-1.13.

In addition to managing corrosion using corrosion management components, a system in accordance with embodiments of the invention may manage the environments in which components and/or corrosion management components reside based on the risk of corrosion occurring. For example, a system may monitor the environmental conditions and/or rates of corrosion that are occurring to determine if a risk of corrosion exists. If the risk of corrosion, even when corrosion management components are utilized, is likely to cause a component to prematurely fail, the system may automatically take steps to modify the environment in which a device subject to corrosion resides to reduce the likelihood that corrosion may cause the device to prematurely fail (e.g., prior to meeting service life goals). In contrast, if the risk of corrosion related failure is low, the system may reduce energy consumption for environmental management purposes during the low corrosion risk times.

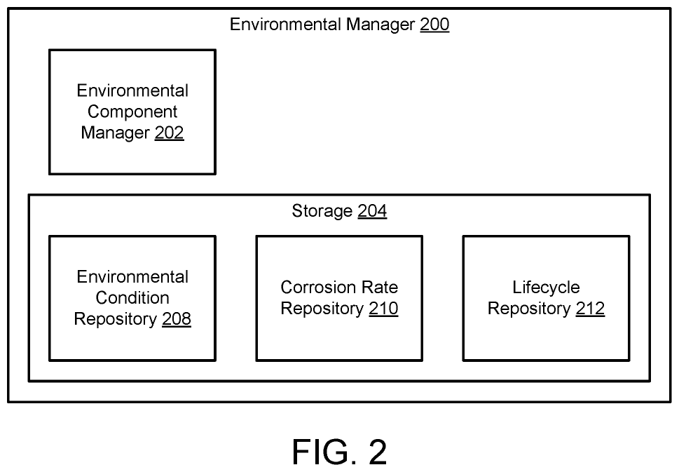

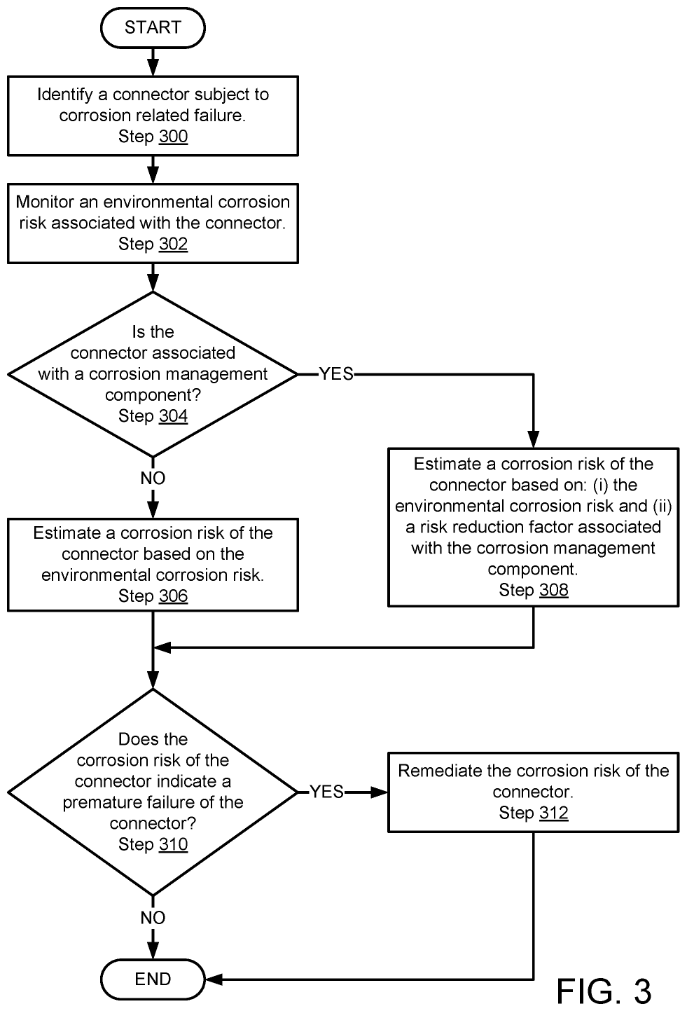

For additional details regarding environment management, refer to FIGS. 2-3.

To further clarify the environments in which corrosion may arise, a diagram of an environment in which a chassis may reside is illustrated in FIG. 1.2 and a diagram of a chassis is provided in FIG. 1.3.

Turning to FIG. 1.2, FIG. 1.2 shows a top view diagram of a building (115) in which chassis may reside in accordance with one or more embodiments of the invention. The building (115) may house a data center (e.g., an aggregation of information handling systems) that includes any number of information handling systems (e.g., 10A, 10B). The information handling systems may include chassis which may need to intake and exhaust gases for temperature regulation purposes.

To facilitate gas management within the building (115), the information handling systems may be organized in rows (or other groupings of information handling systems). In FIG. 1.2, the rows of information handling system extend from top to bottom along the page. To enable gases to be provided to the information handling systems (e.g., for temperature regulation purposes), an airflow conditioner (120) may be disposed within the building. The airflow conditioner (120) may provide supply airflow (122) and take in a return airflow (124). These airflows are illustrated as arrows having dashed tails.

The supply airflow (122) may be at lower temperature than the return airflow (124). Consequently, when information handling systems obtain portions of the supply airflow (122), the information handling systems may be able to utilize the supply airflow (122) to cool components disposed within the chassis of the information handling systems. For example, gases from the supply airflow (122) may be passed by components disposed within chassis of information handling systems that are at elevated temperatures. The gases may be at a lower temperature than the components. Consequently, thermal exchange between the gases and the components may decrease the temperature of the components.

After utilizing the gases from the supply airflow (122), the information handling systems may exhaust the gases as the return airflow (124). After being exhausted from the information handling systems, the return airflow (124) may be obtained by the airflow conditioner (120), cooled, and recirculated as the supply airflow (122).

In addition to cooling the return airflow (124), the airflow conditioner (120) may be capable of obtaining gases from other areas (e.g., outside of the building), reducing the humidity level of an airflow, and/or otherwise conditioning gases for use by information handling systems and/or other devices.

To manage the aforementioned process, a system environmental manager (130) may be disposed within the building (115) or at other locations. The system environmental manager (130) may be a computing device programmed to (i) obtain information regarding the operation of the information handling systems and (ii) set the operating points of the airflow conditioner (120). By doing so, the system environmental manager (130) may cause the airflow conditioner (120) to provide gases to the information handling systems having a temperature and/or humidity level that may better enable the information handling systems to regulate their respective environmental conditions within the chassis of the respective information handling systems. However, conditioning the supply airflow (122) may utilize large amounts of energy.

The airflow conditioner (120) may include functionality to granularly, or at a macro level, modify the temperature and/or humidity level of the supply airflow (122). Consequently, different information handling systems (or groups thereof) may receive different supply airflows (e.g., 122) having different characteristics (e.g., different temperatures and/or humidity levels, different sources, etc.).

Conditioning the return airflow (124) or gases obtained from outside of the building (115) may be costly, consume large amounts of electricity, or may otherwise be undesirable. To reduce these costs, the system environmental manager (130) may set the operating point (e.g., desired temperature/humidity levels of different portions of the supply airflow (122)) of the airflow conditioner (120) to only provide the minimum necessary characteristics required by each of the IHSs for environmental management purposes. By doing so, the cost of providing the supply airflow (122) having characteristics required to meet the environmental requirements of the chassis of the information handling systems may be reduced.

To decide how to set the operating points of the airflow conditioner (120), the system environmental manager (130) may obtain and/or be provided information regarding the environmental conditions within each of the chassis. For example, the system environmental manager (130) may be operably connected to environmental managers of each of the chassis and/or the airflow conditioner (120) via any combination of wired and/or wireless networks. The respective environmental managers of the chassis may provide such information to the system environmental manager (130) and/or service requests regarding the operating points of the airflow conditioner (120) via the operable connections.

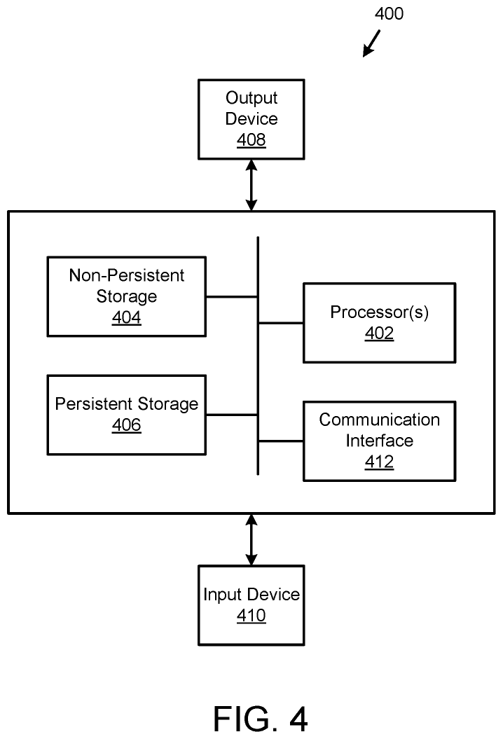

The system environmental manager (130) may be implemented using a computing device. For additional details regarding computing devices, refer to FIG. 4. The system environmental manager (130) may perform all, or a portion, of the method illustrated in FIG. 3 while providing its functionality.

Turning to FIG. 1.3, FIG. 1.3 shows a diagram of a chassis (100A) in accordance with one or more embodiments of the invention. A chassis may be a portion of an IHS and/or house all, or a portion, of an IHS. An information handling system may include a computing device that provides any number of services (e.g., computing implemented services). To provide services, the computing device may utilize computing resources provided by computing components (140). The computing components (140) may include, for example, processors, memory modules, storage devices, special purpose hardware, and/or other types of physical components that contribute to the operation of the computing device. For additional details regarding computing devices, refer to FIG. 4.

Because the computing device uses computing components (140) to provide services, the ability of the computing device to provide services is limited based on the number and/or quantity of computing devices that may be disposed within the chassis. For example, by adding additional processors, memory modules, and/or special purpose hardware devices, the computing device may be provided with additional computing resources which may be used to provide services. Consequently, large number of computing components that each, respectively, generate heat may be disposed within the chassis.

To maintain the temperatures of the computing components (140) (and/or other types of components) within a nominal range, gases may be taken in through an air exchange (102). The gases may be passed by the computing components (140) to exchange heat with them. The heated gases may then be expelled out of another air exchange (102).

However, by taking in and expelling gases used for cooling purposes, the components disposed within the chassis (100A) may be subject to degradation due to corrosion. For example, as discussed above, the gases may include components such as humidity or chemical species that may chemically react with the computing components (140) and/or other types of components disposed in the chassis (100A) forming corrosion. The chemical reaction products (e.g., corrosion) may damage the structure and/or change the electrical properties of the computing components (140). These changes may negatively impact the ability of the computing components (140) to provide their respective functionalities.

For example, the computing components (140) may have a service life during which it is expected that the computing components (140) will be likely to provide its functionality. However, changes in the structure and/or electrical properties of these components due to exposure to humidity or other components of the gases used for temperature regulation purposes may cause the components to prematurely fail ahead of the service life of the computing device due to corrosion formation.

In general, embodiments of the invention provide methods, devices, and systems for managing corrosion within chassis. To manage corrosion, a system in accordance with embodiments of the invention may (i) reduce the likelihood of corrosion occurring, (ii) monitoring the occurrence of corrosion, and (iii) based on the monitoring, modify the internal environment of a chassis to reduce the prevalence of corrosion and/or reduce the amount of power used for environmental management purposes. When determining how much corrosion has occurred during the monitoring, the system may take into account the presence, or lack, of corrosion management components that modify the rates of corrosion of components.

By doing so, embodiments of the invention may reduce the likelihood of components prematurely failing due to corrosion while limiting power consumption. By reducing the likelihood of the occurrence of premature failures of computing components, the computing components (140) disposed within the chassis (100A) may be more likely to meet their respective service life goals, have lower operation costs, and/or require fewer repairs during their respective service life. For additional details regarding the computing components (140), refer to FIG. 1.4.

To manage the internal environment (104) of the chassis, the chassis (100A) may include a chassis environmental manager (150). The chassis environmental manager (150) may provide environmental management services. Environmental management services may include (i) obtaining information regarding the rates of corrosion occurring within the chassis, (ii) determining, based on the corrosion rates, whether the devices within the chassis are likely to meet their service life goals, and (iii) modifying the operation (e.g., modifying operating points) of environmental control components (152) and/or characteristics of gases taken into the chassis to reduce the likelihood of premature failure of components disposed within the chassis (100A) due to corrosion and/or reduce the amount of power consumed for environmental management purposes. For additional details regarding the chassis environmental manager (150), refer to FIG. 2.

While illustrated in FIG. 1.3 as a physical structure, as will be discussed with respect to FIG. 2, the chassis environmental manager (150) may be implemented as a logical entity (e.g., a program executing using the computing components (140)). For example, a computing device disposed in the chassis may host an application (e.g., computer instructions being executed by a processor that cause the processor to perform the functionality of the application) that provides the functionality of the chassis environmental manager (150).

To enable the chassis environmental manager (150) to provide its functionality, the chassis (100A) may include one or more detectors (e.g., 154, 156). These detectors may enable the rates of corrosion of various components disposed within the chassis (100A) to be determined and/or environmental conditions within the chassis to be determined. These detectors may be implemented as sensors or other types of physical devices that are operably connected to the chassis environmental manager (150). Any number of corrosion detectors (e.g., 154), temperature detectors (e.g., 156), humidity detectors (e.g., 156), and/or other types of detectors may be disposed at any number of locations throughout the chassis (100A).

In some embodiments of the invention, the functionality of a temperature detector may be provided by, in all or in part, the computing components (140). For example, the computing components (140) may include functionality to report their respective temperatures and/or temperatures of the internal environment (104) of the chassis (100A).

The chassis (100A) may also include environmental control components (152). The environmental control components (152) may include physical devices that include functionality to modify characteristics (e.g., temperature, relative/absolute humidity level, airflow rates/directions) of the internal environment (104) of the chassis (100A). The chassis (100A) may include any number of environmental control components disposed at any number of locations within the chassis.

For example, the environmental control components (152) may include gas movers such as fans. The fans may be able to modify the rate of gases being taken into and expelled from the chassis (100A) through the air exchangers (e.g., 102). The rate of intake and exhaust of gases may cause an airflow to be generated within the internal environment (104). The airflow may be used to modify the rate of thermal exchange between the computing components (140) and the internal environment (104) (e.g., an environment proximate to the computing components (140)).

In another example, the environmental control components (152) may include heaters. The heaters may be able to modify the temperature of the internal environment (104). For example, heaters may be disposed at a front of the chassis (e.g., where gases are taken into the chassis) and/or about different locations within the chassis. These heaters may be used to generally and/or locally heat the internal environment (104). By doing so, the relative humidity level and temperature of the internal environment (104) proximate to the computing components (140) and/or different components may be controlled. The temperature and/or relative humidity level may be utilized to limit, reduce, or otherwise control corrosion rates of the computing components (140).

In a still further example, the environmental control components (152) may include components that are not disposed in the chassis (not shown). For example, the environmental control components may include an airflow conditioner discussed with respect to FIG. 1.2. These external components may be used in conjunction with the environment control components disposed within the chassis to manage the temperature and/or relative humidity levels throughout the internal environment (104) of the chassis.

The chassis (100A) may include any number and type of environmental control components without departing from the invention. Any of the environmental control components may be implemented using physical devices operably connected to and/or controllable by the chassis environmental manager (150) and/or a system environmental manager (e.g., 130, FIG. 1.2) (alone or in combination). Any number of chassis environmental managers and system environmental managers may cooperatively operate to control the temperature and/or relative humidity levels of the internal environments of any number of chassis to control the rate of corrosion occurring within the chassis and/or manage the thermal load generated by the computing components (140) and/or other components.

To cooperatively operate, the chassis environmental managers and system environmental managers may be operably connected to one another (e.g., via wired and/or wireless networks). The aforementioned components may share information with one another (e.g., detector data, operating set points of different environmental control components, etc.). These components may implement any type of model for controlling and/or delegating control of the system for temperature, relative humidity level, and/or corrosion rate management purposes. When providing their respective functionalities, these components may perform all, or a portion, of the method illustrated in FIG. 3. Any of these components may be implemented using a computing device. For additional details regarding computing devices, refer to FIG. 4.

While the chassis (100A) of FIG. 1.3 has been illustrated as including a limited number of specific components, a chassis in accordance with one or more embodiments of the invention may include additional, fewer, and/or different components without departing from the invention. Additionally, while the chassis (100A) is illustrated as having a specific form factor (e.g., rack mount), a chassis in accordance with embodiments of the invention may have different form factors without departing from the invention.

As discussed above, the chassis (100A) may house computing components (140). Turning to FIG. 1.4, FIG. 1.4 shows a diagram of computing components (140) in accordance with one or more embodiments of the invention. The computing components (140) may enable computing devices to provide services, as discussed above.

The computing components (140) may include any number of integrated discrete hardware devices (160). The integrated discrete hardware devices (160) may include, for example, packaged integrated circuits (e.g., chips). The integrated discrete hardware devices (160) may enable any number and type of functionalities to be performed by a computing device.

The computing components (140) may include any number of connected discrete hardware devices (164). The connected discrete hardware devices (164) may include, for example, modules disposed on circuit cards or other substrates. The connected discrete hardware devices (164) may be operably connected to the integrated discrete hardware devices (160) through a circuit card (166). For example, the circuit card may include a connector (e.g., 168.2) that enables the connected discrete hardware devices (164) to be connected to the circuit card (166). The connector (168.2) may be a slot for a memory module, Peripheral Component Interconnect (PCI) device, or another discrete device having another form factor that enables it to operably connect to the circuit card (166) that interconnects the integrated discrete hardware devices (160). The integrated discrete hardware devices (160) may enable any number and type of functionalities to be performed by a computing device.

The computing components (140) may also include a circuit card (166). The circuit card (166) may enable any of the integrated discrete hardware devices (160) to be operably connected to one another and/or other components not illustrated in FIG. 1.4. For example, in addition to including a connector (e.g., 168.2) that enables connected discrete hardware devices (164) to operably connect to it, the circuit card (166) may also include inter-device connectors (e.g., 168.4). The inter-device connectors (e.g., 168.4) may enable devices having other form factor such as Serial AT Attachment (SATA), power connectors, etc.

The circuit card (166) may include a multilayer printed circuit board that includes circuitry. The circuit card (166) may include traces (162) that electrically interconnect the integrated discrete hardware devices (160) to one another and/or other components not illustrated in FIG. 1.4 via the connectors (e.g., 164, 168.4). The traces (162) may be formed out of conductive materials, such as, copper thereby enabling electrical power to be provided to the integrated discrete hardware devices (160) and other devices, electrical signals to be distributed among the integrated discrete hardware devices (160) and other devices, etc.

Returning to the integrated discrete hardware devices (160), these devices may consume electrical power and generate heat as a byproduct of performing their functionality. Further, the integrated discrete hardware devices (160) may have some sensitivity to temperature. For example, the integrated discrete hardware devices (160) may only operate nominally (e.g., as designed) when the temperatures of the respective integrated discrete hardware devices (160) are maintained within a preferred temperature range. Consequently, all, or a portion, of the integrated discrete hardware devices (160) may require some level of cooling to continue to operate nominally. Similarly, any of the components connected using the connectors (e.g., 168.2, 168.4) may also require cooling.

As discussed above, to facilitate cooling, airflows within the chassis may be generated by environmental control components such as fans, heaters, etc. The airflows may cause gases that are at different temperatures and/or relative humidity levels to be taken into the chassis, used for cooling purposes, and then expelled from the chassis.

However, this process may be problematic because the gases used for cooling purposes may also contribute to corrosion being formed on, for example, the connectors (e.g., 168.2, 168.4). The connectors may be particularly sensitive to corrosion because they may rely on the formation of electrical connections by physically contacting another device. If the connectors corrode where these electrical connections are to be formed, the electrical connections may be prevented from being made. Consequently, the connectors may be unable to perform their function in the presence of corrosion on surfaces which are to form electrical connections with other components. For additional details regarding electrical connection formation between the connectors and other devices, refer to FIGS. 1.5-1.13.

To reduce the impact of corrosion on the connectors (e.g., 168.2, 168.4), corrosion management components may be integrated with these devices. Accordingly, some or all of the connectors employed by an information handling system may be a connector that is integrated with corrosion management components (e.g., 168.2, 168.4). In FIG. 1.4, the connectors that may include integrated corrosion management components are highlighted using dotted infill. Other types of connectors, other than those illustrated in FIG. 1.4, may also include integrated corrosion management components.

In one or more embodiments of the invention, the circuit card (166) includes a connector integrated corrosion management component (168.2). The connector integrated corrosion management component (168.2) may comply with a form factor that enables, for example, memory modules, expansion card, or other types of devices to be connected to the circuit card (166).

In one or more embodiments of the invention, the circuit card (166) includes an inter-device connector integrated corrosion management component (168.4). The inter-device connector integrated corrosion management component (168.4) may comply with a form factor that enables, for example, hard disk drives, solid state drives, universal serial bus enabled devices, serial port enabled devices, and/or other types of devices to be connected to the circuit card (166).

The circuit card (166) may include any number and type of connector that include integrated corrosion management components. Additionally, in some embodiments of the invention, corrosion management components may be integrated on the circuit card (166) proximate to a connector that is not integrated with a corrosion management component. The proximity and electrical connection between the corrosion management component on the circuit card (166) and the connector may enable the corrosion management component to provide corrosion management services to the connector. For example, the corrosion management component may be disposed on a trace that connects to a pin or other electrical contact of a connector. As will be discussed with respect to FIG. 1.5, the electrical connection may enable the corrosion management component to provide corrosion management services to the connector.

For additional details regarding the corrosion management components and integration of such component with connectors, refer to FIGS. 1.5-1.13.

While the computing components (140) are illustrated in FIG. 1.4 as including specific numbers and specific types of components, computing component in accordance with one or more embodiments of the invention may include additional, different, and/or fewer components without departing from the invention.

Turning to FIG. 1.5, FIG. 1.5 shows a side view diagram of the connector integrated corrosion management component (168.2) and a device connector (172) in accordance with one or more embodiments of the invention. As discussed above, the connector integrated corrosion management component (168.2) may enable other devices to operable connect to a circuit card.

To do so, the connector integrated corrosion management component (168.2) may include any number of connector contacts (e.g., 170.2). The connector contacts may be conductive structure adapted to form physical connections with other devices. These physical connections may electrically connect another device to a circuit card through pins (e.g., 172.8) that electrically connect the connector contacts to traces of a circuit card.

The connector integrated corrosion management component (168.2) may also include a housing (172.6). The housing (172.4) may house the connector contacts (170.2). Additionally, the housing (172.4) may support a device that is connected to the connector integrated corrosion management component (168.2). For example, the housing (172.4) may have a shape and include attachment that enables another device to fixedly attached to it. When a device is attached to the housing, contacts of the device may be placed into contact with the connector contacts (e.g., 170.2) thereby forming physical and electrical connections between the device and the connector integrated corrosion management component (168.2).

However, as discussed above, the connector integrated corrosion management component (168.2) may include portions that are sensitive to corrosion. For example, if an interface surface (172.10) of the connector contacts (e.g., 170.2) corrode, the corrosion may prevent an electrical connection from being formed between the connector contacts and another device (or may form a poor electrical connection that may limit the ability of a connected device to send electrical signals through the electrical connection). Consequently, the connector integrated corrosion management component (168.2) may be unable to perform its functionality (e.g., prematurely fail) of connecting another device when corrosion is present on the interface surfaces (172.10) or other areas that are highly sensitive to corrosion.

To reduce the likelihood of premature failure of the connector integrated corrosion management component (168.2) due to corrosion, the connector integrated corrosion management component (168.2) may include connector corrosion management components (172.6). The connector corrosion management components (172.6) may provide corrosion management services to the interface surfaces (e.g., 172.10) of the connector integrated corrosion management component (168.2) and/or other portions of the connector integrated corrosion management component (168.2) that are sensitive to corrosion.

The connector corrosion management components (172.6) may include metals, as discussed above, that may reduce a rate of corrosion of the connector contact (170.2). To do so, the connector corrosion management components (172.6) may be disposed on the connector contacts (e.g., 170.2) in low impact areas (e.g., 170.7). The low impact areas may be disposed away from the interface surfaces and/or other areas that are highly impacted by corrosion.

The connector corrosion management components (172.6) may be disposed on portions of the connector contacts that are opposite of the interface surfaces (e.g., 172.10). Consequently, when the connector corrosion management components (172.6) corrode, the corrosion may not interfere with the formation of electrical connections between the connector contacts and other devices.

For example, the device connector (172) may be a portion of a device that may connect to the connector integrated corrosion management component (168.2). The portion of the device may be, for example, an edge connector. The edge connector may include any number of device connector contacts (172.4). The device connector contacts (172.4) may have shapes, sizes, positions, and orientations that cause them to contact corresponding connector contacts (e.g., 170.2) when the device connector (172) is received by the connector integrated corrosion management component (168.2). For a view of the device connector (172) received by the connector integrated corrosion management component (168.2), refer to FIG. 1.13.

In some embodiments of the invention, the device connector (172) may also include corrosion management components. For example, device connector corrosion management components (172.2) may be integrated with the device connector contacts (172.4) to reduce the rate of these contacts corroding. By doing so, the surfaces of these contacts that physically connect to one another may corrode at reduced rates thereby enabling them to continue to form electrical contacts for longer durations of time and/or in environments that are more likely to cause corrosion to occur.

Like the connector corrosion management components (172.6), the device connector corrosion management components (172.2) may be disposed at locations away from surfaces of the device connector (172) used to form electrical and physical contacts, which may be disrupted if corrosion is formed. For additional details regarding corrosion formation, its impact on physical and electrical connection formation, and mitigation of such corrosion, refer to FIGS. 1.6-1.12.

Turning to FIGS. 1.6-1.12, these figures show side view diagram of a connector contact (170.2) as the connector contact (170.2) corrodes. In FIGS. 1.6-1.9, the connector contact (170.2) is not being provided corrosion management services by a corrosion management component resulting in the connector contact being unable to form electrical connections. In FIGS. 1.10-1.12, the connector contact (170.2) is being provided corrosion management services by a corrosion management component resulting in the connector being able to form electrical connections even as corrosion is formed.

Turning to FIG. 1.6, FIG. 1.6 shows a first side view diagram of the connector contact (170.2) near where the connector contact (170.2) would contact another device to form a connection. At the point in time illustrated in FIG. 1.6, the connector contact (170.2) has not corroded.

Due to the risk of corrosion, the connector contact (170.2) includes a protective layer (174.4) disposed on a structural metal (174.2). The structural metal (174.2) provides the connector contact (170.2) with its physical shape and ability to hold its shape. Additionally, the structural metal (174.2) is electrically conductive thereby enabling it to be used to form electrical connections with other devices.

The protective layer (174.4) may be a layer of metal disposed on the structural metal (174.2). The protective layer (174.4) may be formed from a material that is likely to corrode at a slow rate. For example, the protective layer (174.4) may include gold that is likely to corrode at slow rates.

By virtue of its slow rate of corrosion, the protective layer (174.4) may reduce the impact of corrosion on the connector contact (170.2). However, the reduced impact provided by the protective layer (174.4) may be insufficient. As will be discussed with respect to FIGS. 1.7-1.9, corrosion related failure of the connector contact (170.2) may still occur even when a protective layer (174.4) is utilized.

Turning to FIG. 1.7, FIG. 1.7 shows a second side view diagram of the connector contact (170.2) in accordance with one or more embodiments of the invention. As seen in FIG. 1.7, corrosion (174.6) has started to form on the structural metal (174.2). In FIG. 1.7, the protective layer (174.4) may still enable a physical and electrical connection to still be formed between the connector contact (170.2) and another device.

However, due to diffusion, pin holing of the protective layer (174.4), and/or other forces acting on the connector contact (170.2), corrosion has started to form below the protective layer by reacting with the structural metal (174.2). Consequently, corrosion products that are larger in size than the structural metal (174.2) have started to aggregate between the structural metal (174.2) and the protective layer (174.4).

Turning to FIG. 1.8, FIG. 1.8 shows a third side view diagram of the connector contact (170.2) in accordance with one or more embodiments of the invention. FIG. 1.8 shows a diagram of the connector contact (170.2) after corroding for a period of time.

As seen in FIG. 1.8, the corrosion (174.6) has expanded in size when compared to FIG. 1.7, penetrated through the protective layer (174.4), and formed a surface protrusion (174.8) of corrosion products on a surface of the connector contact (170.2). The corrosion products forming the surface protrusion (174.8) are not conductive or substantially less conducive than the structural metal (174.2).

A surface protrusion (174.8) may be formed after a connector contact has been exposed to an environment that is corrosion. For example, humidity or reactive chemical species in an ambient environment may begin interacting with the structural metal (174.2) thereby forming the corrosion (174.6) and corresponding surface protrusion (174.8). The surface protrusion (174.8) may be of very small size (e.g., micrometer scale).

While the connector contact (170.2) is illustrated in FIG. 1.8 as including a single source of corrosion (174.6) and a single corresponding surface protrusion (174.8), any number of surface protrusions (174.8) may be formed on a connector contact (170.2) due to environmental conditions within a chassis in which the connector contact (170.2) is disposed.

Turning to FIG. 1.9, FIG. 1.9 shows a fourth side view diagram of the connector contact (170.2) in accordance with one or more embodiments of the invention. In FIG. 1.9, a device connector contact (176) is attempting to mate (e.g., be pressed against) with the connector contact (170.2). To do so, a surface of the device connector contact (176) may need to be placed in direct contact with the connector contact (170.2). More specifically, portions of these two contact having appropriate levels of conductivity may need to be disposed against one another to form a desirable electrical connection between the contacts.

However, as seen in FIG. 1.9, the surface protrusion (174.8) limits the ability of the device connector contact (176) to physically touch the connector contact (170.2). Consequently, a gap (178) between the protective layer (174.4) (and/or structural metal (174.2)) and the device connector contact (176) is formed. Due to the lack of contact between these conductive portions of the respective contact, the only physical contact between these contacts is through the surface protrusion (174.8) of the corrosion.

Due to the low conductivity of the corrosion products that form the surface protrusion (174.8), a very poor electrical connection is formed. The quality of the electrical connection is of such poor quality that the connector contact (170.2) cannot be used to operably connect a device in which the device connector contact (176) is incorporated to a circuit card.

Turning to FIGS. 1.10-1.12 these figures show similar side view diagram to those illustrated in FIGS. 1.16-1.9. However, a corrosion management component (180) is integrated with the connector contact (170.2) in these figures.

Turning to FIG. 1.10, FIG. 1.10 shows a first side view diagram of the connector contact (170.2) with an integrated corrosion management component (180) in accordance with one or more embodiments of the invention. As seen in FIG. 1.10, the corrosion management component (180) is implemented as a block of material disposed on a side of the connector contact (170.2) opposite the side that will physical contact another component.

Turning to FIG. 1.11, FIG. 1.11 shows a second side view diagram of the connector contact (170.2) with the integrated corrosion management component (180) in accordance with one or more embodiments of the invention. In FIG. 1.11, time has passed with respect to the point in time illustrated in FIG. 1.10. Consequently, corrosion (174.6) has formed. In contrast to FIGS. 1.6-1.9, the corrosion has formed on the corrosion management component (180) preferentially over forming on the protective layer (174.4) or structural metal (174.2). The corrosion has formed on the corrosion management component (180) because it modified the chemical reactivity of the structural metal (174.2), on which the corrosion management component (180) is directly disposed, while the corrosion occurred.

Specifically, the corrosion management component (180) reduced the corrosion susceptibility of the structural metal (174.2). Accordingly, when the connector contact (170.2) was exposed to an environment conductive to corrosion, the corrosion management component (180) corroded and now prevents the structural metal layer (174.2) and/or protective layer (174.4) from corroding.

Additionally, by virtue of its selective placement away from the surface of the protective layer (174.4), the corrosion (174.6) that has formed is unlikely to impact the ability of the connector contact (170.2) to form physical and electrical connections with other components.

Turning to FIG. 1.12, FIG. 1.12 shows a third side view diagram of the connector contact (170.2) with the integrated corrosion management component (180) in accordance with one or more embodiments of the invention. In FIG. 1.12, the connector contact (170.2) has been mated with a device connector (172).

As seen in FIG. 1.12, large amounts of direct contact (182) between the protective layer (174.4) and the device connector contact (176) has been formed. Accordingly, a good quality electrical connection has been formed. The direct contact (182) was obtaining by ensuring that the corrosion (174.6) occurred in a low impact area of the connector contact (170). In other words, away from the portion of the connector contact (170) that must make physical contact with other components.

Turning to FIG. 1.13, FIG. 1.13 shows a side view diagram of the connector integrated corrosion management component (168.2) in accordance with one or more embodiments of the invention. Specifically, FIG. 1.13 shows the connector integrated corrosion management component (168.2) after corrosion (174.6) has formed and the device connector (172) has been mated with the connector integrated corrosion management component (168.2).

As seen from FIG. 1.13, by strategically disposing the corrosion management components in low impact areas (170.7) of the device connector (172) and the connector integrated corrosion management component (168.2), direct contact (182) between the connector contact (170.2) and the device connector (172) has been achieved after formation of corrosion (174.6).

By disposing the corrosion management components in the low impact areas (170.7) away from the physical contact surfaces of the device connector (172) and the connector integrated corrosion management component (168.2), high quality direct contact (182) is achieved because protrusion formed from corrosion products are not present in these areas even though other portions of these components have corroded. The aforementioned corrosion distribution was achieved by lowering the reactivity of the contacts (e.g., 170.2) while the connector integrated corrosion management component (168.2) was exposed to a corrosive environment (e.g., high enough relative humidity level).

By virtue of the direct contact (182) between these connectors, an electrical connection between the device connector (172) and a circuit card on which the connector integrated corrosion management component (168.2) is disposed has been formed. The electrical connection may enable electrical power and signals to be transmitted to and from the device connector (172).

For example, if the device connector (172) is a portion of a memory module, power may be supplied to the memory module to enable to operate. Consequently, the memory module may store and supply stored information to other devices. Similarly, digital information may be transmitted to and from the memory module using electrical signals transmitted through the device connector (172). Accordingly, digital information encoded in the electrical signals may be supplied to or received from the memory module via the device connector (172).

While the connector integrated corrosion management component (168.2), connector contacts (e.g., 172.8), and device connector (172) have each been illustrated as including a limited number of specific components, any of these components may include different portions, fewer portions, and/or additional portions without departing from the invention.

Additionally, while in FIGS. 1.5-1.13 the corrosion management components have been illustrated as discrete portions of material, a corrosion management component in accordance with embodiments of the invention may take other forms. For example, a corrosion management component may be implemented as a metal layer. With respect to FIGS. 1.10-1.12, the corrosion management component may be formed as a metal layer disposed between the structural metal and the protective layer (or at other location in the stack).

Further, while illustrated in FIGS. 1.5 and 1.13 as being disposed on the connector contact (170.2), the corrosion management components may be disposed on, for example, the pins to the circuit card (172.8) and/or portions of the circuit card connected to the pins to the circuit card (172.8) without departing form the invention.

In addition, while illustrated in FIGS. 1.5 and 1.13 with respect to connector integrated corrosion management components (e.g., 168.2) having a specific form factor, corrosion management components may be integrated with other types of connector form factors without departing from the invention. Corrosion management components may be integrated with any type of connector to reduce the connector's susceptibility to contact surface corrosion without departing form the invention.

As noted above, to reduce the likelihood of premature failure of IHSs, an IHS in accordance with embodiments of the invention may include an environmental manager that takes into account the presence, or lack, of corrosion management components integrated into connectors. Turning to FIG. 2, FIG. 2 shows a diagram of an environmental manager (200) in accordance with one or more embodiments of the invention. The system environmental manager (130) and/or chassis environmental manager (150) illustrated in FIGS. 1.2 and 1.3, respectively, may be similar to the environmental manager (200). The functionality of the environmental manager may be provided in part, or entirely, by any number of system environmental managers (e.g., 130, FIG. 1.2) and/or chassis environmental managers (e.g., 150, FIG. 1.3)

As discussed above, the environmental manager (200) may provide environmental management services. Environmental management services may reduce the likelihood that IHSs fail prematurely (e.g., prior to meeting service life goals) due to corrosion of components such as connectors of the IHSs. When providing its services, the environmental manager may estimate the corrosion levels of connectors based on the presence or lack of corrosion management components. By doing so, the environmental manager may be likely to predict when connectors are likely to fail due to corrosion.

In one or more embodiments of the invention, the environmental manager (200) is implemented using computing devices. The computing devices may be, for example, mobile phones, tablet computers, laptop computers, desktop computers, servers, distributed computing systems, embedded computing devices, or a cloud resource. The computing devices may include one or more processors, memory (e.g., random access memory), and persistent storage (e.g., disk drives, solid state drives, etc.). The persistent storage may store computer instructions, e.g., computer code, that (when executed by the processor(s) of the computing device) cause the computing device to provide the functionality of the environmental manager (200) described through this application and all, or a portion, of the method illustrated in FIG. 3. The environmental manager (200) may be implemented using other types of computing devices without departing from the invention. For additional details regarding computing devices, refer to FIG. 4.

In one or more embodiments of the invention, the environmental manager (200) is implemented using distributed computing devices. As used herein, a distributed computing device refers to functionality provided by a logical device that utilizes the computing resources of one or more separate and/or distinct computing devices. For example, in one or more embodiments of the invention, the environmental manager (200) is implemented using distributed devices that include components distributed across any number of separate and/or distinct computing devices. In such a scenario, the functionality of the environmental manager (200) may be performed by multiple, different computing devices without departing from the invention.

To provide environmental management services, the environmental manager (200) may include an environmental component manager (202) and a storage (204). Each of these components is discussed below.

The environmental component manager (202) may manage the components (e.g., connectors) of the chassis and/or other components that may be used to control the characteristics (e.g., temperature, humidity level, airflow rates, etc.) of the internal environment of the chassis. To manage them, the environmental component manager (202) may (i) obtain information regarding the environmental conditions within the chassis including temperatures, humidity levels, airflow rates, and/or corrosion rates, (ii) determine, using the environmental information, whether the IHS is likely to prematurely fail due to corrosion of connectors, (iii) if the IHS is unlikely to meet its service life goals due to premature failure of connectors, modify the characteristics of the internal environment of the chassis to improve the likelihood that the IHS will meet its service life goals, and (iv) if the HIS is likely to meets its service life goals due to low levels of corrosion of connectors, modify the characteristics of the internal environment of the chassis to reduce energy consumption (which may increase the rates of corrosion).

To obtain information regarding the environmental conditions, the environmental component manager (202) may request such information from computing components (e.g., temperatures), detectors (e.g., corrosion, temperature, humidity, and/or other types of sensors), and/or other types of devices (e.g., components external to the chassis). In response, the aforementioned components may provide the requested information to the environmental component manager (202). The environmental component manager (202) may store the aforementioned information as part of an environmental condition repository (208). Consequently, a historical record of the conditions in the chassis may be formed. These historical records may be used to identify the likely levels of corrosion of components (e.g., connectors) over time.

To ascertain whether an IHS is likely to prematurely fail due to corrosion of connectors, the environmental component manager (202) may estimate a total amount of corrosion that has likely occurred, estimate the rate that corrosion will occur in the future, and use the previous amount and current rate of corrosion to determine whether the HIS is likely to prematurely fail (or be impaired by, not all connector failures cause IHS failures) due to a corrosion related connector failure. To generate the estimates, the environmental component manager (202) takes into account environmental conditions and whether any of the connectors are associated with corrosion management components that may reduce the rates of corrosion of the corresponding connectors.

Utilizing these estimates, the environmental component manager (202) may determine whether the IHS is unlikely to meet its service life goal (e.g., operate without impairment/failure) due to corrosion related failures of connectors. To make this determination, the environmental component manager (202) may utilize a lifecycle repository (212). The lifecycle repository (212) may specify information that may be used to ascertain whether a premature failure will occur based on corrosion. For example, the lifecycle repository (212) may specify a total amount of corrosion that will cause various connectors of the IHS to fail. Based on this aggregate amount and the corrosion rate associated with the respective connectors (estimated based on the historical environmental conditions and/or direct measurements of corrosion), the environmental component manager (202) may ascertain whether the amount of corrosion specified by the lifecycle repository (212) will be exceeded prior to the occurrence of the service life of the IHS being met.

If it is determined that the IHS will prematurely fail or be impaired due to corrosion of one or more of its connectors, the environmental component manager (202) may modify the operation of one or more environmental control components to reduce the corrosion rate within the chassis. For example, the environmental component manager (202) may increase the ambient temperature within the chassis, decrease the relative humidity level, modify airflow rates within the chassis, and/or otherwise modify the internal environment of the chassis to reduce the rate that corrosion occurs in the chassis. By doing so, the point in time at which the IHS is likely to fail due to corrosion may be pushed into the future thereby reducing the likelihood that the IHS will prematurely fail ahead of its service life being completed.

When providing its functionality, the environmental component manager (202) may utilize the storage (204) by storing and using previously stored data structures.

To provide the above noted functionality of the environmental component manager (202), the environmental component manager (202) may perform all, or a portion, of the method illustrated in FIG. 3.

In one or more embodiments of the invention, the environmental component manager (202) is implemented using a hardware device including circuitry. The environmental component manager (202) may be implemented using, for example, a digital signal processor, a field programmable gate array, or an application specific integrated circuit. The environmental component manager (202) may be implemented using other types of hardware devices without departing from the invention.

In one or more embodiments of the invention, the environmental component manager (202) is implemented using computing code stored on a persistent storage that when executed by a processor performs all, or a portion, of the functionality of the environmental component manager (202). The processor may be a hardware processor including circuitry such as, for example, a central processing unit or a microcontroller. The processor may be other types of hardware devices for processing digital information without departing from the invention.

In one or more embodiments disclosed herein, the storage (204) is implemented using devices that provide data storage services (e.g., storing data and providing copies of previously stored data). The devices that provide data storage services may include hardware devices and/or logical devices. For example, storage (204) may include any quantity and/or combination of memory devices (i.e., volatile storage), long term storage devices (i.e., persistent storage), other types of hardware devices that may provide short term and/or long term data storage services, and/or logical storage devices (e.g., virtual persistent storage/virtual volatile storage).

For example, storage (204) may include a memory device (e.g., a dual in line memory device) in which data is stored and from which copies of previously stored data are provided. In another example, storage (204) may include a persistent storage device (e.g., a solid state disk drive) in which data is stored and from which copies of previously stored data are provided. In a still further example, storage (204) may include (i) a memory device (e.g., a dual in line memory device) in which data is stored and from which copies of previously stored data are provided and (ii) a persistent storage device that stores a copy of the data stored in the memory device (e.g., to provide a copy of the data in the event that power loss or other issues with the memory device that may impact its ability to maintain the copy of the data cause the memory device to lose the data).

The storage (204) may store data structures including an environmental condition repository (208), a corrosion rate repository (210), and a lifecycle repository (212). Each of these data structures is discussed below.

The environmental condition repository (208) may include one or more data structures that include information regarding the environmental conditions within a chassis. For example, when temperature, humidity, airflow rate, and/or corrosion data is read from a detector, the read information may be stored in the environmental condition repository (208). Consequently, a historical record of the environmental conditions in the repository may be maintained.

The environmental condition repository (208) may include any type and quantity of information regarding the environmental conditions within the repository. For example, the environmental condition repository (208) may include temperature sensor data from discrete temperature sensors and/or temperature sensors integrated into computing components (and/or other types of devices). In another example, the environmental condition repository (208) may include corrosion rates from discrete or integrated corrosion detectors (e.g., on board a circuit card). In a still further example, the environmental condition repository (208) may include airflow rate data regarding the flow of gases within a chassis.

In addition to the sensor data, the environmental condition repository (208) may include spatial data regarding the relative locations of components within a chassis. For example, some connectors may be disposed away from the detectors. Consequently, it may not be possible to directly measure the temperature, relative humidity level, airflow rates, and/or corrosion of such connectors. The spatial data may be used to estimate, using measured temperatures and/or corrosion, the likely corrosion rates of the connectors.

Additionally, the environmental condition repository (208) may include information regarding whether connectors are associated with (e.g., provided with corrosion management services) corrosion management components. For connectors that are associated with corrosion management components, the environmental condition repository (208) may specify correction factors with respect to the rates of corrosion of these connectors for corresponding environmental conditions. For example, if a connector has a measured temperature of 70° Fahrenheit and 70% relative humidity, the environmental condition repository (208) may specify that the connector has a high rate of corrosion. However, if the connector is associated with a corrosion management component, the environmental condition repository (208) may specify a risk reduction factor that may be applied to the corrosion rate to obtain an estimate of the corrosion rate of the connector that takes into account the presence of the corrosion management component.

The corrosion rate repository (210) may include one or more data structures that include information regarding the rates at which connectors disposed in the chassis have corroded. For example, the corrosion rate repository (210) may include tables associated with different connectors disposed within the chassis. Each of these tables may include the measured and/or estimated corrosion of the connectors.

The tables may also include the time at which the corrosion was measured. Consequently, the rates of corrosion of the connectors may be ascertained using the information included in the tables (e.g., corrosion at time T1-corrosion at time T2/the different between T1 and T2).

The lifecycle repository (212) may include one or more data structures that include information regarding the desired life of components disposed in a chassis of an information handling system. For example, the lifecycle repository (212) may specify how much corrosion may occur with respect to different connectors before the respective connectors are likely to fail. The aforementioned information may be used in conjunction with determined corrosion rates and quantities of corrosion included in the corrosion rate repository (210) to determine whether it is likely that a connector, computing device that incorporates the connector, and/or IHS including the connector is likely to fail prior to its desired service life due to corrosion of the connector (and/or be impaired by corrosion of the connector).

To determine whether a connector is likely to fail or be impaired by corrosion, a prediction model may be used. A prediction model may, based on historical behavior, predict the future corrosion behavior of a connector. The prediction model may be, for example, a machine learning model, a stochastic method, regression (e.g., curve fitting), or any other method of predicting future behavior based on past behavior.

To identify the future corrosion of a connector, the historical corrosion of the connector and/or environmental conditions imposed on the connector may be used to train the predictive model. In other words, the past relationships between environmental conditions and corrosion may be used to a train a function that predicts the future corrosion of the connector based on measured corrosion/environmental conditions.

Once trained, the predictive model may be used to predict when the connector will fail in the future. If the failure time occurs prior to a service life goal being met, the connector (and/or a device incorporating the connector° may be determined as being subject to premature failure or impaired functionality based on the likely future failure of the connector.

While the data structures stored in storage (204) have been described as including a limited amount of specific information, any of the data structures stored in storage (204) may include additional, less, and/or different information without departing from the embodiments disclosed herein. Further, the aforementioned data structures may be combined, subdivided into any number of data structures, may be stored in other locations (e.g., in a storage hosted by another device), and/or spanned across any number of devices without departing from the embodiments disclosed herein. Any of these data structures may be implemented using, for example, lists, table, linked lists, databases, or any other type of data structures usable for storage of the aforementioned information.

While the environmental manager (200) of FIG. 2 has been described and illustrated as including a limited number of specific components for the sake of brevity, an environmental manager in accordance with embodiments of the invention may include additional, fewer, and/or different components than those illustrated in FIG. 2 without departing from the invention.

Further, any of the components may be implemented as a service spanning multiple devices. For example, multiple computing devices housed in multiple chassis may each run respective instances of the environmental component manager (202). Each of these instances may communicate and cooperate to provide the functionality of the environmental component manager (202).

Returning to FIG. 2, the environmental manager (200) may provide environmental management services that take into account the presence, or lack, of corrosion management components that manage the corrosion of connectors. FIG. 3 illustrates a method that may be performed by the environmental manager (200) of FIG. 2 when providing environmental management services.

FIG. 3 shows a flowchart of a method in accordance with one or more embodiments of the invention. The method depicted in FIG. 3 may be used to manage the internal environment of a chassis in accordance with one or more embodiments of the invention. The method shown in FIG. 3 may be performed by, for example, an environmental manager (e.g., 200, FIG. 2). Other components of the system illustrated in FIGS. 1.1-1.10 may perform all, or a portion, of the method of FIG. 3 without departing from the invention.

While FIG. 3 is illustrated as a series of steps, any of the steps may be omitted, performed in a different order, additional steps may be included, and/or any or all of the steps may be performed in a parallel and/or partially overlapping manner without departing from the invention.

In step 300, a connector subject to corrosion related failure is identified. The connector may be identified using information included in a lifecycle repository. For example, the lifecycle repository may include a list of connectors that are subject to corrosion related failure and amounts of corrosion that may cause their failures. Any of these connectors included in the list may be the identified connector.

In step 302, an environmental corrosion risk associated with the connector is identified. The environmental corrosion risk may be identified based on detector measurements of the environment in which the connector resides. For example, the temperature, relative humidity level, and/or other conditions that may impact corrosion may be monitored using detectors. These environmental conditions may be used as the environmental corrosion risk.

These measurements may be used to estimate the corrosion of the connector over time. For example, as a computing device operates, its connectors may be subject to corrosion. The temperature, relative humidity level, and/or other environmental conditions may be used to determine how much the connector has corroded over time. The result may be a listing of total corrosion (and/or rates over time) of a connector over time. Similarly, the corresponding environmental conditions over time may also be recorded.

In step 304, it is determined whether the connector is associated with a corrosion management component. The determination may be made based on information included in an environmental condition repository (208, FIG. 2). The environmental condition repository may specify each connector that is associated with a corrosion management component. The environmental condition repository may also specify correction factors that are associated with the corrosion management components associated with the connectors listed in the repository.

If it is determined that the connector is not associated with any corrosion management components, the method may proceed to step 306. If it is determined that the connector is associated with a corrosion management component, the method may proceed to step 308.

In step 306, a corrosion risk of the connector is estimated based on the environmental corrosion risk. For example, the environmental corrosion risk may be associated with corresponding levels of corrosion based on a composition of the connector and the environmental conditions to which the connector was disposed. The association may be determined in a laboratory environment and provided (e.g., stored in storage of or otherwise made available to) to an environmental manager.

For example, the corrosion risk of the connector may be functionally related to the environmental corrosion risk. The corrosion risk of the connector may be computed by providing the environmental corrosion risk (e.g., environmental conditions) as input to the functional relationship.

The relationship between environmental conditions and corrosion risk may be used to generate a time sequence of the corrosion of the connector over time.

Returning to step 304, the method may proceed to step 308 following step 304 if it is determined that the connector is associated with a corrosion management component.

In step 308, a corrosion risk of the connector is estimated based on (i) the environmental corrosion risk and (ii) a risk reduction factor associated with the corrosion management component.

As discussed with respect to step 306, the corrosion risk of the connector (e.g., how quickly the component is corroding) may be functionally related to the environmental corrosion risk. To take into account the presence of the corrosion management component, a risk reduction factor (e.g., correction factor) may be applied to the output of the functional relationship to obtain the estimate of the corrosion risk of the connector. In other words, the corrosion risk of the connector based only on the environmental risk may be first calculated. Then, a risk reduction factor may be applied to obtain the corrosion risk of the connector to reflect it being associated (e.g., in direct contact with) with a corrosion management component.

The risk reduction factor may be based on, for example, the type, material composition, shape, method of integration of the corrosion management component with the connector, and/or characteristics of the connector (e.g., shape, material composition, etc.). The risk reduction factor may be determined based on laboratory measurement and may be provided to the environmental manager prior to the performance of the method illustrated in FIG. 3.

The result of applying the risk reduction factor may be a time sequence of the corrosion of the connector over time.

The method may proceed to step 310 follow step 306 and/or step 308.

In step 310, it is determined whether the corrosion risk of the connector indicates a premature failure of the connector. The determination may be made by using the corrosion risk of the connector to determine whether the connector is likely to prematurely fail before the service life the connector is met. For example, it may be assumed that the rate of corrosion indicated by the corrosion risk of the connector will remain constant and the duration of time between the current point in time and the future point in time at which failure is likely to occur may be determined. The future point in time may then be compared to the service life of the connector to ascertain whether the rate of corrosion will result in a premature failure that occurs prior to the service life of the connector being met. The service life of the connector may be specified by a lifecycle repository.

The determination may be made by comparing the amount of corrosion of the connector that has occurred and the corrosion rate to a maximum amount of corrosion that can occur before failure of the connector is likely (e.g., specified in a lifecycle repository). In other words, solving the equation C_{f}=C_{c}+T*Cᵣ where C_{f} is the amount of corrosion that can occur before premature failure is likely to occur, C_{c} is the amount of corrosion that has already occurred, Cᵣ is the corrosion rate determined in steps 306 and/or 308, and T is the unknown amount of time until premature failure will occur due to corrosion. If the amount of time until premature failure indicates that failure of the connector will occur before the desired service life of the connector occurs, it is determined that the corrosion rates indicates a premature failure of the connector will occur.

In one or more embodiments of the invention, the determination is made by estimating the future rates/absolute quantities of corrosion using a predictive model. The predictive model may be, for example, machine learning, a stochastic method, a regression technique (e.g., linear regression/curve fitting), or any other method of using historical data to predict future data.

The historical corrosion and/or corrosion rates obtained in steps 306 and/or 308 may be used as training data to train a predictive model. The predictive model may be used to then predict the future levels of corrosion of the connector based on the historical data. The predicted future levels of corrosion may specify, for example, the amount of corrosion of the connector at different points in the future and/or the rates of change of the corrosion at different points in time in the future.

These predictions may be used to ascertain when the corrosion risk of the connector indicates a premature failure (e.g., whether the connector will fail prior to meeting service life goals). If the connector will not meet is service life goals based on the prediction, the corrosion risk may indicate the premature failure of the connector.

If it is determined that the rate of corrosion indicates a premature failure of the connector, the method may proceed to step 312. If it is determined that the rate of corrosion does not indicate premature failure of the connector, the method may end following step 310.

In step 312, the corrosion risk of the connector is remediated. The corrosion risk of the connector may be remediated by modifying the environmental conditions within the chassis to reduce corrosion of the connector.

For example, the temperature of gases supplied to the chassis may be increased, the rate of gas flow through the chassis may be decreased, humidity may be removed from the gases supplied to the chassis, and/or other changes to the environment may be made. These changes may be made by modifying operating points of environmental management components.

To modify the operating points of the environmental management components, messages may be sent to the environmental management components indicating that changes are to be made, rates of power supplied to the environmental management components may be changed (e.g., reduced), and/or other modifications may be made.

The aforementioned changes may be made in a manner that minimizes the consumption of power for such purposes. In other words, reduction in that amount of corrosion due to these changes may be minimized such that the connector is likely to meet its service life goal.

When an how to determine when to modify the future environmental conditions may be made based, in part, on the predictive model obtained in step 310. For example, the predictive model may be utilized to determine at which future points in time the rate of corrosion may be high. During these periods of high corrosion rate time in the future, the environmental manager may schedule use of larger amounts of power to better condition the environment thereby proactively reducing the corrosion rates to meet service life goals.

In contrast, during predicted future periods of time when corrosion rates are low, the system may reduce power consumption for environmental conditioning purposes. Consequently, reduced levels of power may be consumed for conditioning purposes during low corrosion rate periods of time in the future.

The method may end following step 312.

Using the method illustrated in FIG. 3, embodiments of the invention may provide a system that manages conditions within a chassis to limit corrosion to meet service life goals.

The environmental manager (200) of FIG. 2 may be implemented as a distributed computing device. As used herein, a distributed computing device refers to functionality provided by a logical device that utilizes the computing resources of one or more separate and/or distinct computing devices.

Additionally, as discussed above, embodiments of the invention may be implemented using a computing device. FIG. 4 shows a diagram of a computing device in accordance with one or more embodiments of the invention. The computing device (400) may include one or more computer processors (402), non-persistent storage (404) (e.g., volatile memory, such as random access memory (RAM), cache memory), persistent storage (406) (e.g., a hard disk, an optical drive such as a compact disk (CD) drive or digital versatile disk (DVD) drive, a flash memory, etc.), a communication interface (412) (e.g., Bluetooth interface, infrared interface, network interface, optical interface, etc.), input devices (410), output devices (408), and numerous other elements (not shown) and functionalities. Each of these components is described below.

In one embodiment of the invention, the computer processor(s) (402) may be an integrated circuit for processing instructions. For example, the computer processor(s) may be one or more cores or micro-cores of a processor. The computing device (400) may also include one or more input devices (410), such as a touchscreen, keyboard, mouse, microphone, touchpad, electronic pen, or any other type of input device. Further, the communication interface (412) may include an integrated circuit for connecting the computing device (400) to a network (not shown) (e.g., a local area network (LAN), a wide area network (WAN) such as the Internet, mobile network, or any other type of network) and/or to another device, such as another computing device.

In one embodiment of the invention, the computing device (400) may include one or more output devices (408), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (402), non-persistent storage (404), and persistent storage (406). Many different types of computing devices exist, and the aforementioned input and output device(s) may take other forms.

Embodiments of the invention may provide an improved method for managing components of an information handling system. Specifically, embodiments of the invention may provide a method and device for managing corrosion of connectors of IHSs. To do so, embodiments of the invention may provide a system that utilizes corrosion management components to reduce the rates of corrosion of the connectors. By doing so, premature failures due to corrosion of connectors may be prevents and IHSs may be utilized in environments with environmental conditions that would otherwise cause the IHSs to prematurely fail due to corrosion of connectors.

Thus, embodiments of the invention may address the problem of environments that may cause premature failures of devices due to corrosion of their connectors. Specifically, embodiments of the invention may provide a method of managing corrosion that enables less power to be consumed for environmental conditioning purposes while still mitigating the impacts of corrosion related failures.

The problems discussed above should be understood as being examples of problems solved by embodiments of the invention disclosed herein and the invention should not be limited to solving the same/similar problems. The disclosed invention is broadly applicable to address a range of problems beyond those discussed herein.

One or more embodiments of the invention may be implemented using instructions executed by one or more processors of the data management device. Further, such instructions may correspond to computer readable instructions that are stored on one or more non-transitory computer readable mediums.

While the invention has been described above with respect to a limited number of embodiments, those skilled in the art, having the benefit of this disclosure, will appreciate that other embodiments can be devised which do not depart from the scope of the invention as disclosed herein. Accordingly, the scope of the invention should be limited only by the attached claims.

What is claimed is:

1. A computing device of an information handling system, comprising:
a connector adapted to receive a component, the connector comprising a contact adapted to form a physical connection, with the component, that supports an electrical connection between the connector and the component, wherein the contact comprises an interface surface, disposed in a high corrosion risk area of the connector, that forms the physical connection with the component while the component is disposed in the connector; and
a corrosion management component adapted to:
reduce a rate of corrosion of the contact in the high corrosion risk area of the connector; and
increase a second rate of corrosion in a low corrosion risk area of the connector.

2. The computing device of claim 1, wherein the corrosion management component comprises:
a sacrificial anode of a material that is more chemically active than the connector.

3. The computing device of claim 2, wherein the sacrificial anode comprises a metal layer disposed between a protective layer of the contact and a structural metal of the contact.

4. The computing device of claim 2, wherein the sacrificial anode comprises metal plug disposed on a surface of the contact in the low corrosion risk area.

5. The computing device of claim 2, wherein the sacrificial anode comprises a metal selected from a group consisting of zinc, aluminum, and magnesium.

6. The computing device of claim 1, wherein the high corrosion risk area of the connector comprises features that are unable to perform their functionality if an amount of corrosion in the high corrosion risk area exceeds a threshold.

7. The computing device of claim 6, wherein the low corrosion risk area of the connector comprises second features that are insensitive to corrosion.

8. The computing device of claim 1, wherein the corrosion management component is disposed on a portion of the contact in the low corrosion risk area of the connector.

9. The computing device of claim 8, wherein the portion of the contact in the low corrosion risk area of the connector is electrically connected to the interface surface.

10. The computing device of claim 9, further comprising:
an environmental manager programmed to:
monitor an environmental corrosion risk associated with the connector;
make a determination that the connector is associated with the corrosion management component;
in response to the determination:
estimate a corrosion risk of the connector based on:
the environmental corrosion risk, and
a risk reduction factor associated with the corrosion management component;
make a second determination that the corrosion risk of the connector indicates a premature failure of the connector; and
remediate the corrosion risk of the connector based on the second determination.

11. The computing device of claim 10, wherein remediating the corrosion risk of the connector comprises:
performing an action set comprising at least one selected from the group consisting of:
increasing a temperature of the connector;
decreasing a humidity level of an atmosphere proximate to the connector; and
reducing a rate of flow of the atmosphere proximate to the connector.

12. The computing device of claim 10, wherein the environmental manager is further programmed to:
monitor a second environmental corrosion risk associated with a second connector;
make a third determination that the second connector is not associated with any corrosion management components;
in response to the third determination:
estimate a second corrosion risk of the second connector based on:
the second environmental corrosion risk, and
no risk reduction factors associated with any corrosion management components;
make a fourth determination that the corrosion risk of the second connector indicates a premature failure of the second connector; and
remediate the second corrosion risk of the second connector based on the fourth determination.

13. The computing device of claim 10, wherein the environmental corrosion risk is estimated based on a temperature of the connector and a relative humidity level of an atmosphere proximate to the connector.

14. The computing device of claim 10, wherein the environmental corrosion risk is estimated based on a corrosion rate measured by a corrosion detector.

15. The computing device of claim 10, wherein the risk reduction factor specifies a reduction in a rate of corrosion of the connector based on an electrical potential applied to the connector by the corrosion management component.

16. A method for environmentally managing a computing device of an information handling system, comprising:
monitoring an environmental corrosion risk associated with a connector of the computing device, wherein the connector is physically connected to a corrosion management component adapted to:
reduce a rate of corrosion of the connector in a high corrosion risk area of the connector, and
increase a second rate of corrosion in a low corrosion risk area of the connector;
making a determination that the connector is associated with the corrosion management component;
in response to the determination:
estimating a corrosion risk of the connector based on:
the environmental corrosion risk, and
a risk reduction factor associated with the corrosion management component;
making a second determination that the corrosion risk of the connector indicates a premature failure of the connector; and
remediating the corrosion risk of the connector based on the second determination.

17. The method of claim 16, wherein remediating the corrosion risk of the connector comprises:
performing an action set comprising at least one selected from the group consisting of:
increasing a temperature of the connector;
decreasing a humidity level of an atmosphere proximate to the connector; and
reducing a rate of flow of the atmosphere proximate to the connector.

18. The method of claim 16, further comprising:
monitoring a second environmental corrosion risk associated with a second connector, wherein the second connector is not physically connected to any corrosion management components;
making a third determination that the second connector is not associated with any corrosion management components;
in response to the third determination:
estimating a second corrosion risk of the second connector based on:
the second environmental corrosion risk, and
no risk reduction factors associated with any corrosion management components;
making a fourth determination that the corrosion risk of the second connector indicates a premature failure of the second connector; and
remediating the second corrosion risk of the second connector based on the fourth determination.

19. A non-transitory computer readable medium comprising computer readable program code, which when executed by a computer processor enables the computer processor to perform a method for environmentally managing a computing device of an information handling system, the method comprising:
monitoring an environmental corrosion risk associated with a connector of the computing device, wherein the connector is physically connected to a corrosion management component adapted to:
reduce a rate of corrosion of the connector in a high corrosion risk area of the connector, and
increase a second rate of corrosion in a low corrosion risk area of the connector;
making a determination that the connector is associated with the corrosion management component;
in response to the determination:
estimating a corrosion risk of the connector based on:
the environmental corrosion risk, and
a risk reduction factor associated with the corrosion management component;
making a second determination that the corrosion risk of the connector indicates a premature failure of the connector; and
remediating the corrosion risk of the connector based on the second determination.

20. The non-transitory computer readable medium of claim 19, wherein remediating the corrosion risk of the connector comprises:
performing an action set comprising at least one selected from the group consisting of:
increasing a temperature of the connector;
decreasing a humidity level of an atmosphere proximate to the connector; and
reducing a rate of flow of the atmosphere proximate to the connector.
